(19) United States
(12) Patent Application Publication
(10) Pub. No.: US 2020/0278998 A1
(43) Pub. Date: Sep. 3, 2020

(54) INFORMATION PROCESSING APPARATUS AND NON-TRANSITORY COMPUTER READABLE MEDIUM STORING PROGRAM

(71) Applicant: FUJI XEROX CO., LTD., Tokyo (JP)

(72) Inventors: Masato ANDO, Kanagawa (JP); Hirokazu MUKAI, Kanagawa (JP); Tomoyuki ITO, Kanagawa (JP); Minoru KASAMA, Kanagawa (JP)

(73) Assignee: FUJI XEROX CO., LTD., Tokyo (JP)

(21) Appl. No.: 16/531,125

(22) Filed: Aug. 5, 2019

(30) Foreign Application Priority Data
Feb. 28, 2019 (JP) 2019-036718

(51) Int. Cl. G06F 16/901; G06Q 50/30; G06F 16/9035

(52) U.S. Cl. CPC G06F 16/9027; G06F 16/9035; G06Q 50/30

(57) ABSTRACT

An information processing apparatus includes a display section that displays a branch perspective which is stored in advance in association with an event in a case of creating a relationship diagram representing a structure between plural events.

### CROSS-REFERENCE TO RELATED APPLICATIONS

This application is based on and claims priority under 35 USC 119 from Japanese Patent Application No. 2019-036718 filed Feb. 28, 2019.

### BACKGROUND

### (i) Technical Field

The present invention relates to an information processing apparatus and a non-transitory computer readable medium storing a program.

### (ii) Related Art

In a system that uses a complex physical phenomenon, many events are commonly linked in a chain relationship, for example, in a manner in which there are a plurality of events causing a result such as a final quality of a product, there are also a plurality of events causing the events, and there are further a plurality of events causing the plurality of events, and so on.

In such a complex system, since there are many qualities that have to be met, a cause-and-effect relationship between design groups and quality groups becomes extremely complex. For this reason, it is difficult to find a design item for satisfying a desired quality, and a problem, in that a change in design value for satisfying a certain quality adversely affects another quality, is likely to occur.

There are known several methods for visualizing and organizing a cause-and-effect relationship between complex events. As a representative method, there are a relationship diagram and a quality function development table. The relationship diagram expresses a relationship between events, and expresses a cause-and-effect relationship by connecting an event corresponding to a result and an event corresponding to a cause using a relationship line. A typical example of the relationship diagram is a logic tree. The quality function deployment table is also called a QFD table, and is expressed by symbols or numerical values in a case where axes, in which events are mapped side by side on a half line, are arranged so as to be orthogonal to each other and relationships between events on each axis are arranged in a matrix shape between adjacent axes.

The relationship diagram is useful for illustrating results and causes of the results in detail without omission or duplication. Meanwhile, in a case where the number of target events increases too much, the relationship diagram becomes too complicated and enlarged, and as a result, practical use of the relationship diagram becomes difficult. On the other hand, in the quality function development table, relationships between many results and many causes can be expressed in a simple way by extracting important events from among many events, arranging the extracted important events on the axis, and expressing a cause-and-effect relationship by a matrix. Meanwhile, the quality function development table cannot express a detailed cause-and-effect relationship including events which are not arranged on the axis, and as a result, omission or missing of items is likely to occur. For this reason, it is considered to simply express a cause-and-effect relationship between many events corresponding to causes and many events corresponding to results while extracting and describing the cause-and-effect relationship in detail without omission or duplication by using the relationship diagram and the multi-axis quality function development table together.

JP2014-112338A discloses an information processing apparatus that displays items on an adjacent axis which are associated with items on a certain axis in the quality function development table. The information processing apparatus disclosed in JP2014-112338A extracts, in a case where a first item is selected from items on a certain axis of the quality function development table, a second item from an adjacent axis adjacent to the certain axis by calculating an association between the first item and items belonging to the adjacent axis, extracts a third item from an axis adjacent to the second item by calculating an association between the first item and items belonging to the axis based on an association between the extracted second item and items belonging to the axis, and displays these items. In this way, by analyzing the association between items with a hierarchical structure, the cause-and-effect relationship may be displayed not only in one direction but in alternate directions.

### SUMMARY

Aspects of non-limiting embodiments of the present disclosure relate to an information processing apparatus and a non-transitory computer readable medium storing a program capable of assisting creation of a relationship diagram by presenting a branch perspective which is associated with an event in a case of creating a relationship diagram representing a structure between a plurality of events.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including: a display section that displays a branch perspective which is stored in advance in association with an event in a case of creating a relationship diagram representing a structure between a plurality of events.

### BRIEF DESCRIPTION OF THE DRAWINGS

Exemplary embodiment(s) of the present invention will be described in detail based on the following figures, wherein:

FIG. 1 is an explanatory diagram illustrating an example of a relationship diagram;

FIG. 2 is a configuration diagram illustrating an example of a schematic configuration of an information processing apparatus according to an exemplary embodiment of the present invention;

FIG. 3 is an explanatory diagram illustrating a way of assisting creation of a relationship diagram according to a first exemplary embodiment of the present invention;

FIG. 4 is an explanatory diagram illustrating an example of a branch perspective that is switched and displayed in accordance with a selected event;

FIG. 5 is an explanatory diagram illustrating a way of assisting creation of a relationship diagram according to a second exemplary embodiment of the present invention;

FIG. 6 is an explanatory diagram illustrating a way of assisting creation of a relationship diagram according to a third exemplary embodiment of the present invention; and

FIG. 7 is an explanatory diagram illustrating a way of assisting creation of a relationship diagram according to a fourth exemplary embodiment of the present invention.

### DETAILED DESCRIPTION

Description of Relationship Diagram

The present invention is for assisting creation of a relationship diagram by presenting a branch perspective which is associated with an event in a case of creating a relationship diagram representing a structure of a cause-and-effect relationship between a plurality of events as various events. Firstly, the relationship diagram will be briefly described. In order to visualize the structure of the cause-and-effect relationship between events, the relationship diagram is a tree diagram (logic tree) obtained by connecting shapes describing events to each other by lines according to a dependence state based on a dependence relationship between the events.

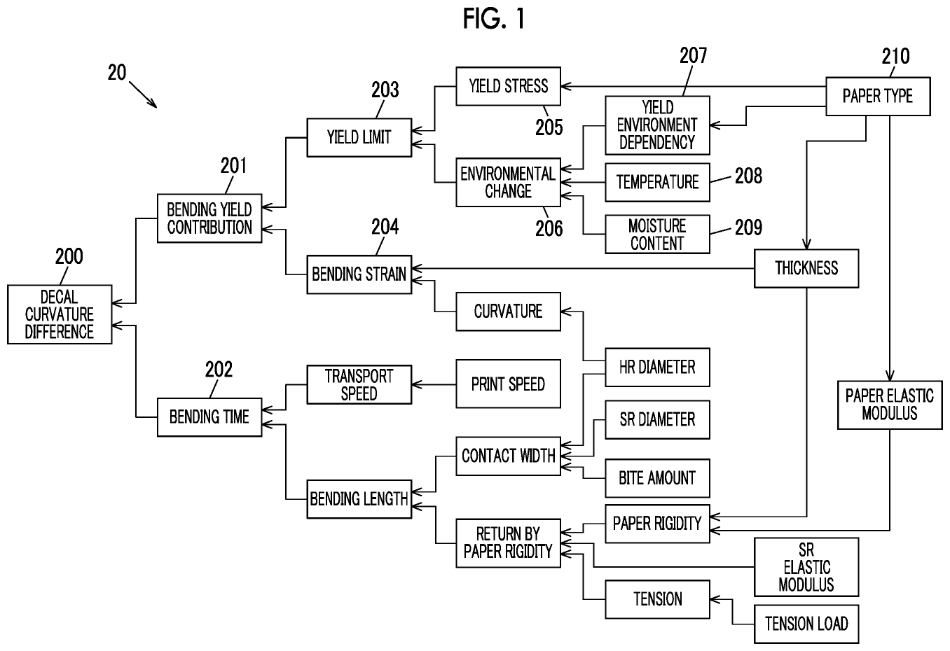

FIG. 1 illustrates an example of a relationship diagram. A relationship diagram has, for example, a hierarchical structure including a product quality required by a customer, a function for realizing the quality, a physical characteristic value for realizing the function, and a design parameter (control parameter) for realizing the physical characteristic value.

A part of the relationship diagram 20 illustrated in FIG. 1 will be described. First, there is a decal curvature difference 200 as a printing paper quality required by a customer. As a function for realizing the decal curvature difference 200, there are a bending yield contribution 201 and a bending time 202. As a physical characteristic for realizing the bending yield contribution 201, there are a yield limit 203 and a bending strain 204. Further, as the physical characteristic for realizing the yield limit 203, there are a yield stress 205, an environmental change 206, and yield environment dependency 207. As a design parameter for realizing the yield stress 205 and yield environment dependency 207, there is a paper type 210, and as a design parameter for realizing the environmental change 206, there are a temperature 208 and a moisture content 209.

In the relationship diagram 20, the events are connected to each other by a line with an arrow at the end. In this case, the event at the beginning of the arrow represents a cause, and the event at the end of the arrow represents a result. Thus, for example, the bending yield contribution 201 and the bending time 202 are associated with the decal curvature difference 200. Further, in the relationship diagram 20, all of the lines representing the relationship between the events are represented by the same line. On the other hand, a thickness and a line type of the line may be changed and displayed depending on the relationship between the events.

In manufacturing of a product, for example, in a case where the paper type 210 as a design parameter on the lowermost layer is changed, the yield stress 205 is changed due to the change of the paper type 210. As the yield stress 205 is changed, the yield limit 203 is changed, and as the yield limit 203 is changed, the bending yield contribution 201 is changed. Thereby, the decal curvature difference 200 as required quality is influenced. In designing of a product, in order to obtain finally-required quality, the paper type 210 and other design parameters are determined. Therefore, it is important to create the relationship diagram such that there is no omission or duplication.

### First Exemplary Embodiment

Hereinafter, a first exemplary embodiment of the present invention will be described in detail with reference to the drawings.

Configuration of Information Processing Apparatus

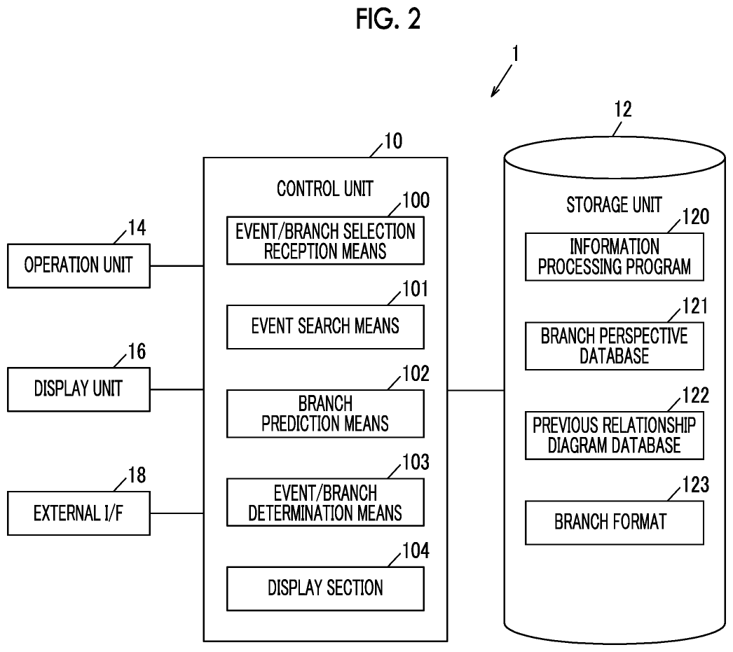

FIG. 2 is a configuration diagram illustrating a schematic configuration of an information processing apparatus according to an exemplary embodiment of the present invention. As illustrated in FIG. 2, the information processing apparatus 1 includes a control unit 10, a storage unit 12, an operation unit 14, a display unit 16, and an external I/F 18.

The control unit 10 includes a central processing unit (CPU), a memory, and the like, and controls each unit and executes various programs.

The control unit 10 includes event/branch selection reception means 100, event search means 101, branch prediction means 102, event/branch determination means 103, and a display section 104.

The storage unit 12 is configured with a storage device such as a hard disk drive (HDD) or a flash memory, and stores information.

The storage unit 12 stores an information processing program 120, and includes a branch perspective database 121, a previous relationship diagram database 122, and a branch format 123.

As the operation unit 14, a keyboard, a mouse, a touch panel, and the like may be appropriately selected and used. The display unit 16 displays a text, an image, and the like, and is configured with a display device such as a liquid crystal display (LCD). The external I/F 18 is for connecting the information processing apparatus 1 to an external database or another system apparatus via a line or the like.

The control unit 10 executes the information processing program 120 stored in the storage unit 12, and thus functions as the event/branch selection reception means 100, the event search means 101, the branch prediction means 102, the event/branch determination means 103, and the display section 104.

The event/branch selection reception means 100 receives a fact indicating that a creator selects an event or a branch via the operation unit 14 while viewing information displayed on the display unit 16 in a case of creating the relationship diagram. The event search means 101 searches for, as required, branch structure information of a branch portion including an event and a plurality of events which are associated with the event, from the previous relationship diagram database 122 in which previous relationship diagrams are accumulated.

In a case where the creator selects one event during creation of the relationship diagram, the branch prediction means 102 predicts a way of a branching in association with the event. In a case where the creator selects an event or a branch from among several candidates during creation of the relationship diagram, the event/branch determination means 103 determines the selected event or branch as a component of the relationship diagram, and organizes the relationship diagram.

The display section 104 displays various information such as the relationship diagram and branch candidates, on the display unit 16, in order to assist creation of the relationship diagram by the creator.

The information processing program 120 stored in the storage unit 12 causes the control unit 10 to function as each means described above. In the branch perspective database 121, branch perspectives which are associated with events are accumulated in advance as a template or a database.

The previous relationship diagram database 122 is a database in which pieces of information of relationship diagrams previously created are accumulated. The branch format 123 stores a format for creating a branch perspective that allows the creator to list available dictionaries as branch item candidates.

Operation According to First Exemplary Embodiment

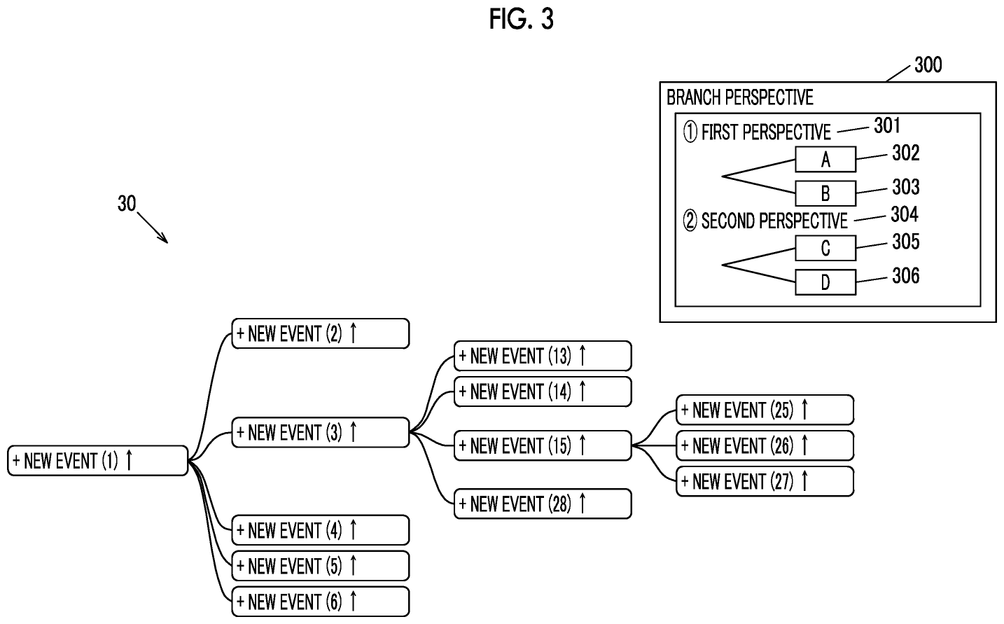

Next, an operation of the information processing apparatus 1 according to the first exemplary embodiment of the present invention will be described with reference to FIG. 3.

FIG. 3 is an explanatory diagram illustrating a way of assisting creation of a relationship diagram according to the first exemplary embodiment of the present invention. As described above, the relationship diagram has a structure including four layers of a quality, a function, a physical property value, and a design parameter. In the relationship diagram 30 illustrated in FIG. 3, a leftmost new event (1) corresponds to a quality, new events (2) to (6) on the right of the leftmost new event (1) correspond to functions, new events (13) to (15) and (28) on the right of the new events (2) to (6) correspond to physical characteristic values, and rightmost new events (25) to (27) correspond to design parameters.

In the relationship diagram 30 illustrated in FIG. 3, an up arrow is entered in a frame indicating each event such as the new event (1) or the like, and the up arrow represents that a value of the event is increased. In fact, there are an up arrow and a down arrow, and the down arrow represents that a value of the event is decreased. For example, the up arrow is entered in frames of the new event (1) and the new event (2). It means that, in a case where a value of the new event (2) is increased, a value of the new event (1) is also increased.

Hereinafter, an operation of creating the relationship diagram with assistance according to execution of the information processing program 120 will be described.

In a case of creating the relationship diagram 30 as illustrated in FIG. 3, first, an event (component) as the leftmost new event (1) is input via the operation unit 14. In response to input of the event, the event/branch selection reception means 100 receives the event and displays the event on the display unit 16 via the display section 104. At this stage, only a frame of the leftmost new event (1) in FIG. 3 is displayed with the event currently entered therein.

Thereby, an event causing the new event (1) as a result, that is, a branch component candidate for the event causing the new event (1), is displayed as a branch perspective by the information processing program 120. At this time, the branch perspective may be automatically displayed. Alternatively, in a case where the creator is inquired as to whether or not to display the branch perspective and the creator requests display of the branch perspective, the branch perspective may be displayed. The branch perspective means a branch structure of a tree diagram in which, in a case where there are a plurality of events that correspond to a selected event and cause or bring the selected event, the selected event is set as a parent event and the plurality of events causing or bringing the selected event are set child events.

In a state where the branch perspectives are displayed, in a case where the creator selects a branch perspective from among the displayed branch perspectives, the event/branch selection reception means 100 receives the selected branch perspective, and the event/branch determination means 103 requests the creator to confirm the selected branch perspective and requests the display section 104 to display the confirmed branch perspective. Thereby, for example, the new events (2) to (6) illustrated in FIG. 3 are determined as branch events for the new event (1), and are added to the relationship diagram.

Next, the new events (13) to (15) and (28) are determined in the same manner, for example, as branch events for the new event (3).

For example, a case of determining the branch events for the new event (13) will be described in detail.

In a case where the creator selects the new event (13) and inputs a specific event in the frame of the new event (13), as illustrated in FIG. 3, the display section 104 displays branch perspectives 300 on a display screen as a balloon. In the example of FIG. 3, in the branch perspectives 300, A 302 and B 303 are displayed as a first perspective 301, and C 305 and D 306 are displayed as a second perspective 304.

In displaying of the branch perspectives for a certain event, the branch perspectives may be automatically displayed in a case where the creator selects a certain event, or the branch perspectives may be displayed in a case where the creator confirms whether or not to display the branch perspectives and instructs display of the branch perspectives.

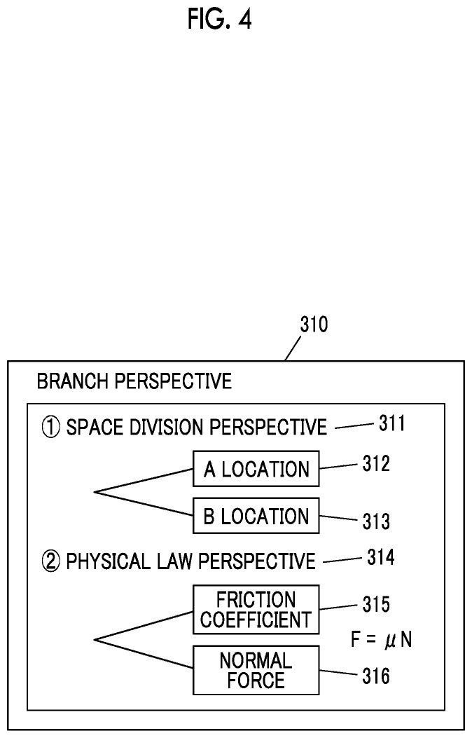

Here, the display section 104 switches and displays the branch perspectives 300 according to the event selected on the display screen on which the relationship diagram is displayed. FIG. 4 illustrates an example of the branch perspectives which are switched and displayed according to the selected event.

As illustrated in FIG. 4, for example, for a specific event which is input as the new event (13) by the creator, as the first perspective, a space division perspective 311 including A location 312 and B location 313 is displayed, and as a second aspect, a physical law perspective 314, which includes friction coefficient 315 and normal force 316 based on a physical law equation F=μN, is displayed.

The creator may select an optimal perspective from the branch perspectives displayed on the display unit 16. In a case where the creator selects an optimal perspective, the event/branch selection reception means 100 receives the selected perspective, and the display section 104 displays the received perspective on the display unit 16, as a branch event for the new event (13). In this way, a branch selected from the display screen displaying the relationship diagram is added to the relationship diagram.

In a case where the creator confirms the added branch, the event/branch determination means 103 determines the added branch as a branch event for the new event (13). In this way, branch events are determined for each event, and thus the relationship diagram is created.

### Second Exemplary Embodiment

Next, a second exemplary embodiment according to the present invention will be described.

A configuration of the information processing apparatus according to the second exemplary embodiment is the same as the configuration illustrated in FIG. 2 as in the first exemplary embodiment. In the second exemplary embodiment, in order to assist creation of the relationship diagram by the creator, the display section 104 displays the branch perspectives by setting a cause-and-effect relationship between events and a positional relationship in the relationship diagram as attributes, searching for events from the database (previous relationship diagram database 122) in which previously-created relationship diagrams are accumulated, using the cause-and-effect relationship and the positional relationship in the relationship diagram as the attributes, and displaying searched events as candidates in descending order of matching degree.

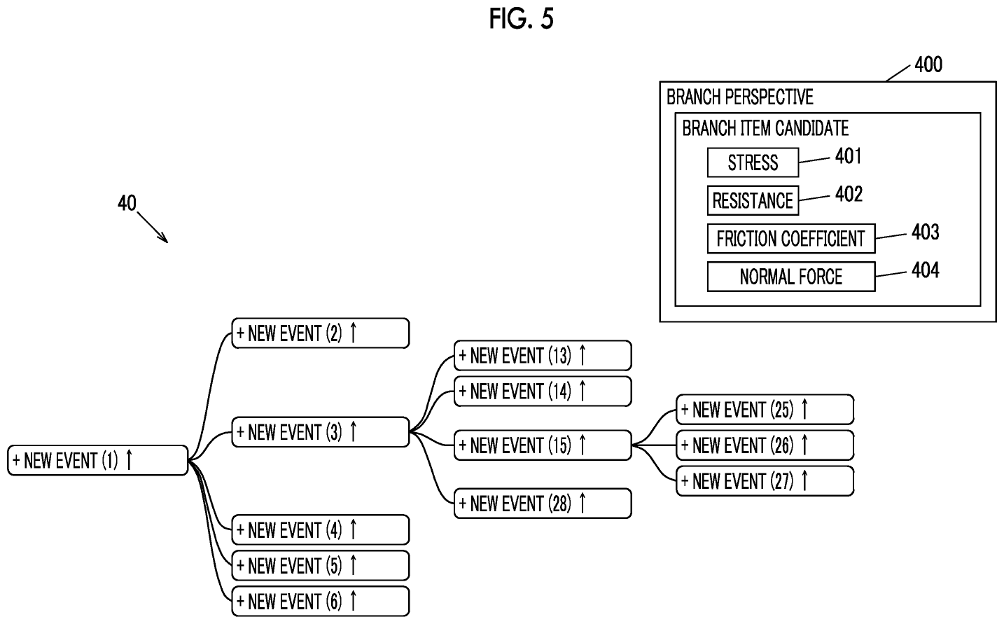

FIG. 5 is an explanatory diagram illustrating a way of assisting creation of a relationship diagram according to the second exemplary embodiment of the present invention. Even in the second exemplary embodiment, as illustrated in the relationship diagram 40 of FIG. 5, a relationship diagram is created with a tree diagram structure in which the leftmost new event (1) is branched to the right events.

Here, a case of obtaining events, which are branched from the new event (13) to the right, will be described. In a case where an event as the new event (13) is input, the event search means 101 searches for events associated with the new event (13), from the previous relationship diagram database 122, using the cause-and-effect relationship and the positional relationship in the relationship diagram as attributes, and extracts an event with a high matching degree. The display section 104 displays, as a branch item candidate, the event extracted by the event search means 101, on the display unit 16.

For example, it is assumed that “paper thickness” as a paper attribute is selected for the new event (13). In this regard, as illustrated in FIG. 5, in branch perspectives 400, stress 401, resistance 402, friction coefficient 403, and normal force 404 are displayed in a balloon on the relationship diagram 40, as branch item candidates associated with “paper thickness”.

The creator confirms the display, and selects some (or all) of the branch item candidates displayed in the branch perspectives 400. Thereby, a new event which is branched from the new event (13) is mapped on the right of the new event (13).

### Third Exemplary Embodiment

Next, a third exemplary embodiment according to the present invention will be described.

A configuration of the information processing apparatus according to the third exemplary embodiment is the same as the configuration illustrated in FIG. 2 as in the first exemplary embodiment. In the third exemplary embodiment, in order to assist creation of the relationship diagram by the creator, in a case where the creator selects one branch during creation of the relationship diagram, the display section 104 predicts a way of branching in parallel or in series with the selected branch, and displays a predicted branch.

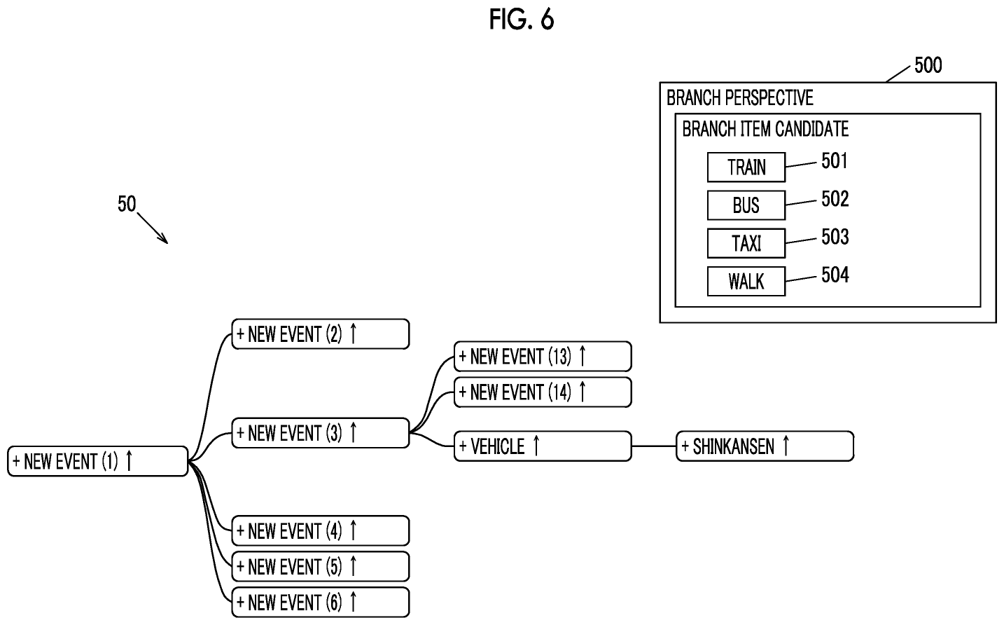

FIG. 6 is an explanatory diagram illustrating a way of assisting creation of a relationship diagram according to the third exemplary embodiment of the present invention. In the relationship diagram 50 of FIG. 6, it is assumed that the creator selects Shinkansen 52 as one event corresponding to one branch of vehicles 51.

In this case, the branch prediction means 102 predicts, as other branch item candidates, train 501, bus 502, taxi 503, and walk 504, which correspond to other vehicles, for example, in a parallel relationship with Shinkansen 52 corresponding to one branch of the vehicles 51.

The display section 104 displays branch perspectives 500 including the branch item candidates predicted by the branch prediction means 102, on the display unit 16. Here, the branch item candidates, which are in a parallel relationship with the selected one branch item, are displayed. On the other hand, in some cases, only the branch item candidates, which are in a serial relationship with the selected one branch item, may be predicted and displayed. Further, the creator may select which branch item to predict.

### Fourth Exemplary Embodiment

Next, a fourth exemplary embodiment according to the present invention will be described.

A configuration of the information processing apparatus according to the fourth exemplary embodiment is the same as the configuration illustrated in FIG. 2 as in the first exemplary embodiment. In the fourth exemplary embodiment, by providing a format for creating branch perspectives that allows the creator himself/herself to think of branch item candidates and to list many branch item candidates, it is possible to assist creation of the relationship diagram by the creator.

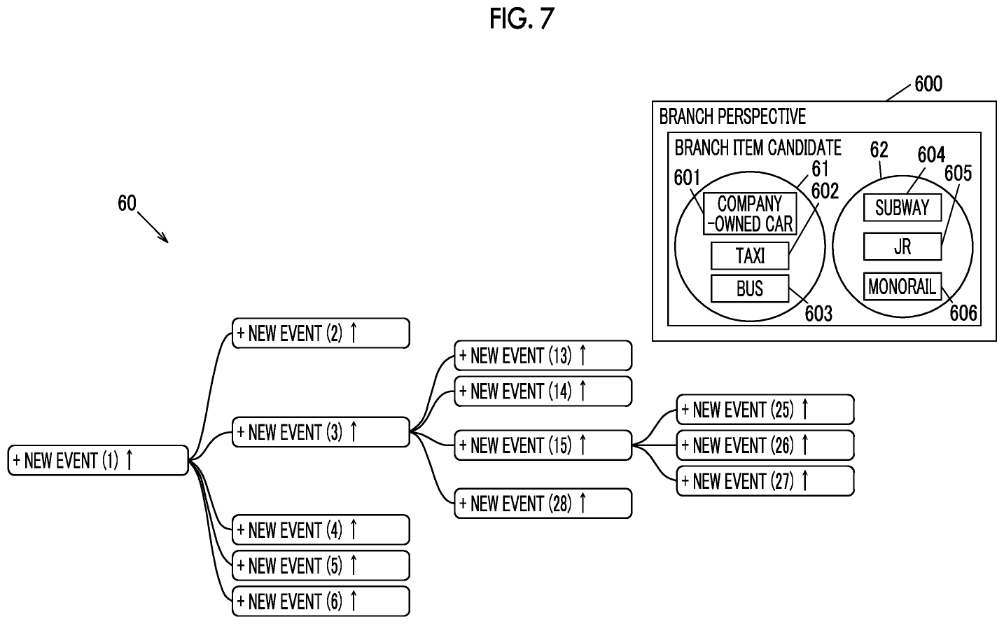

FIG. 7 is an explanatory diagram illustrating a way of assisting creation of a relationship diagram according to the fourth exemplary embodiment of the present invention. In a relationship diagram 60 illustrated in FIG. 7, a case of creating a branch of a new event (13) is considered. It is assumed that the creator himself/herself creates branch perspectives of the new event (13), for example, for vehicles. In this case, the display section 104 causes the display unit 16 to display a format which allows the creator to list branch item candidates.

As illustrated in FIG. 7, the creator writes, as branch items for vehicles, specific vehicles such as company-owned car 601, taxi 602, bus 603, subway 604, JR 605, or monorail 606, in a frame of the branch perspective 600 via the operation unit 14, as the creator himself/herself thinks. Ina case where the creator cannot think of a branch item, for example, many branch items may be listed from a plurality of persons by brainstorming or the like.

Thereafter, the creator creates the branch perspective by encircling and grouping the vehicles which are listed a lot, for example, like car 61 and railway 62. As described above, in the present exemplary embodiment, in a case where the creator himself/herself creates the branch perspective, the display section 104 provides a format for creating the branch perspective. Thereby, it is possible to assist creation of the relationship diagram.

While exemplary embodiments of the present invention have been described, the present invention is not limited to the exemplary embodiments. The present invention may be freely modified in various ways without departing from the spirit of the inventions. For example, the information processing program 120 according to the exemplary embodiment may be provided by being stored in a recording medium such as a CD-ROM.

In addition, the program used in the exemplary embodiment may be stored in an external server such as a cloud server, and may be used via a network.

Further, some or all of components of the control unit 10 may be configured with hardware circuits such as field programmable gate array (FPGA) and application specific integrated circuits (ASIC).

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a display section that displays a branch perspective which is stored in advance in association with an event in a case of creating a relationship diagram representing a structure between a plurality of events.

2. The information processing apparatus according to claim 1,
wherein the display section switches and displays the branch perspective according to the event selected from a display screen on which the relationship diagram is displayed.

3. The information processing apparatus according to claim 1,
wherein the display section extracts the branch perspective with a high matching degree, from information of the stored relationship diagram, using a cause-and-effect relationship between the events and a positional relationship in the relationship diagram as attributes, and displays the extracted branch perspective.

4. The information processing apparatus according to claim 2,
wherein the display section extracts the branch perspective with a high matching degree, from information of the stored relationship diagram, using a cause-and-effect relationship between the events and a positional relationship in the relationship diagram as attributes, and displays the extracted branch perspective.

5. The information processing apparatus according to claim 1,
wherein, in a case where one branch is selected, the display section predicts a way of branching in parallel or in series with the selected branch, and displays a predicted branch.

6. The information processing apparatus according to claim 1,
wherein the display section presents a plurality of branches and allows a user to edit the plurality of branches.

7. The information processing apparatus according to claim 2,
wherein the display section adds a branch selected from the display screen for displaying the relationship diagram, to the relationship diagram.

8. The information processing apparatus according to claim 3,
wherein the display section adds a branch selected from the display screen for displaying the relationship diagram, to the relationship diagram.

9. The information processing apparatus according to claim 4,
wherein the display section adds a branch selected from the display screen for displaying the relationship diagram, to the relationship diagram.

10. The information processing apparatus according to claim 5,
wherein the display section adds a branch selected from the display screen for displaying the relationship diagram, to the relationship diagram.

11. The information processing apparatus according to claim 6,
wherein the display section adds a branch selected from the display screen for displaying the relationship diagram, to the relationship diagram.

12. A non-transitory computer readable medium storing a program causing a computer to function as:
a display section that displays a branch perspective which is stored in advance in association with an event in a case of creating a relationship diagram representing a structure between a plurality of events.

13. An information processing apparatus comprising:
display means for displaying a branch perspective which is stored in advance in association with an event in a case of creating a relationship diagram representing a structure between a plurality of events.
